(19) United States
(12) Patent Application Publication
(10) Pub. No.: US 2012/0094392 A1
(43) Pub. Date: Apr. 19, 2012

(54) DETERMINATION OF AT LEAST ONE PARAMETER OF A PHYSICAL AND/OR CHEMICAL TRANSFORMATION

(75) Inventors: Jean-Christophe Batsale, Beguey (FR); Christophe Pradere, Villenave D'ornon (FR); Bertrand Pavageau, Villenave D'ornon (FR); Cindy Hany, Saint Caprais de Bodeaux (CH); Jean Toutain, Bordeaux (FR)

(73) Assignees: UNIVERSITE DE BORDEAUX 1, Talence (FR); RHODIA OPERATIONS, Aubervilliers (FR)

(21) Appl. No.: 12/920,380

(22) PCT Filed: Mar. 2, 2009
(86) PCT No.: PCT/EP09/50331

§ 371 Date: Dec. 27, 2011

(30) Foreign Application Priority Data
Mar. 3, 2008 (FR) 08 51355

(51) Int. Cl. G01N 21/75; G01N 25/00

(52) U.S. Cl. 436/164; 422/82.05; 374/45

(57) ABSTRACT

Physico-chemical systems subject to transformation are flowed in a flow member, while maintaining the external periphery of the wall of such flow member at one and the same temperature, with the exception of a display zone, at least between two remote points along said member; at least one spatial distribution of the temperature of the physico-chemical system along this display zone is displayed, in particular comprising an infrared camera, and the or each parameter is determined therefrom utilizing the or each spatial temperature distribution.

The present invention relates to a method of determining at least one parameter of a physical and/or chemical transformation, to a device for carrying out said method, and to a unit comprising at least said device.

The term “transformation” means any type of interaction that is capable of occurring in a mixture of at least two components. In a non-limiting manner, said transformation may be a chemical and/or physical type reaction, such as any conventional type of chemical reaction, for example, as well as crystallization or precipitation or, inter alia, modification of a liquid/vapor equilibrium.

In general, in the context of the invention, said transformation is capable of involving chemical phenomena by exchanging or sharing electrons, or physical interactions or repulsions, such as hydrogen bonds, electrostatic interactions, steric attractions or repulsions, affinities for different hydrophilic and/or hydrophobic media, formulation stabilities, flocculations, or phase transfers, for example of the liquid/liquid, solid/liquid or gas/liquid type. In the context of the invention, a system that is capable of undergoing such a transformation is termed a physico-chemical system.

In the context of the invention, the parameters of said transformation are, in particular, thermodynamic in nature. In this regard, it is the enthalpy of the transformation that is involved, in particular. However, those parameters may also, in a non-limiting manner, be the kinetics of the chemical reaction in a homogeneous or heterogeneous medium, or conditions enabling an optimum yield for the chemical reactions to be obtained.

It should be noted that the invention also enables energy-type transformations to be studied, such as viscous dissipations wherein the flow of a high viscosity substance results in the production of heat. The invention can also provide access to a parameter of that substance, for example a value for its viscosity.

Characterizing the thermodynamic and kinetic parameters of a transformation is of the utmost importance in the development and safety of chemical processes. Two major phenomena are present in such a transformation, namely heat transfer and kinetics; these may be studied via calorimetry.

The first type of calorimetry, conventional calorimetry, has in particular been described in “A. Zogg, F. Stoessel, U. Fischer, K. Hungerbühler, Isothermal reaction calorimetry as a tool for kinetic analysis, Thermochim. Acta, 419, p 1-17, 2004”. That solution uses a jacketed reaction chamber in which an auxiliary liquid flows.

According to one of the implementations in that publication, the reagents are admitted into said chamber then, after they have been mixed, the temperature of the auxiliary liquid flowing in the jacket is varied. Next, the change in the temperature difference between that liquid and the internal volume of the reaction chamber is measured in order to determine the corresponding reaction enthalpy.

That first solution suffers from certain problems, however, in particular linked to the fact that it involves the use of large volumes of reagents. Further, it is not easy to control the mixing time for said reagents since the corresponding manipulations may prove to be particularly lengthly. Finally, that solution does not completely remove the risk of explosions since large volumes are used that may prove to be particularly dangerous for the user.

Methods known as “microcalorimetry” are also known as described, for example, in “I. Wadsö, Thermochim. Acta, 294, p 1-11, 1997”. That solution investigates very small variations in temperature, while using relatively large reaction volumes. It is operated in a closed reaction medium at constant volume.

That alternative solution, which is of application to reactions associated with a very low energy, requires analytical equipment that is extremely accurate and consequently very expensive. Further, in order to carry it out, heat loss must be avoided as much as possible; that turns out to be complicated.

A microfluidic device has also been proposed that can detect real time changes in the enthalpy of biochemical reactions; see “Y. Zhang, S. Tagigadapa, Biosens. Bioelectron., 19, p 1733-1743, 2004”. That publication teaches that a reaction volume is cut into said microfluidic device and is gradually filled by the progressive inflow of the reagents. The variation in temperature is then measured as a function of volume using miniaturized thermopiles that are produced in the form of thin heat-sensitive films.

That solution also suffers from certain problems, linked first of all to the fact that such heat-sensitive films do not have a reference temperature since the temperature of said films varies as the reaction progresses. Further, in order for the measurements to have the correct degree of accuracy, it is necessary for the device to be maintained in surroundings that are as adiabatic as possible. Finally, the equipment employed is highly complex, as well as expensive.

Furthermore, FR-A-2 004 343 discloses a method of determining at least one parameter of a chemical reaction in which the reagents flow in a channel. The overall heat flux associated with the reaction is then measured using a thermopile.

However, that known solution, however, is not entirely satisfactory since only surface information can be accessed, namely of an overall rather than local nature. Hence, the unit described in that document cannot readily be used to deduce a large number of parameters.

The invention therefore aims to overcome the various disadvantages of the prior art mentioned above. In general, furthermore, industry is constantly seeking to develop novel substances with novel properties, for example novel chemical compounds or novel compositions comprising novel chemicals and/or novel combinations of chemicals. Physical and/or chemical transformations of substances are important properties for many applications; they usually need to be tested in research and development procedures. There is a need for methods and units for accelerating research and development procedures, for example in order to test a larger number of substances and/or to carry out tests on smaller quantities of substances, and/or to carry out the tests more rapidly, and/or to carry out tests concerning transformations that are too slow to be studied in the devices proposed in the known prior art.

The intention of the invention is thus to propose a method that enables at least one parameter of a transformation, especially a thermodynamic parameter, to be determined reliably in an economic manner using relatively small quantities of substances that can undergo that transformation. The intention is also to propose such a method that allows the parameters employed to follow that transformation to be varied rapidly and readily, in particular the concentration, the flow rate, and the residence time of the above-mentioned substances.

Finally, the invention aims to propose said method for the purposes of accessing a large amount of data concerning the transformation in question, as well as accessing information of a local nature regarding that transformation.

To this end, the invention provides a method of determining at least one parameter of a physical and/or chemical transformation, the method comprising the following steps:
making a physico-chemical system that can undergo said transformation flow in a flow means while maintaining the external periphery of the wall of said flow means at the same temperature, with the exception of an observation zone at least between two axially separated points of said flow means, respectively designated upstream and downstream points;
observing at least one spatial distribution of the temperature of the physico-chemical system along said observation zone, between said two points, upstream and downstream, at at least one time; and
deducing the or each parameter from the or each spatial temperature distribution.

According to other characteristics of the invention:
the flow means has a thermally insulating wall and a contact zone of said wall is maintained at the same temperature by bringing it into contact with a solid, thermally conductive means, while the observation zone is not brought into contact with said solid means;
the respective upstream and downstream points of the flow means correspond to the inlet and outlet of the contact zone of said flow means with the thermally conductive means;
the flow means is a tubular means that may be removably fastened to the thermally conductive means;
the or each spatial distribution of the temperature is observed using an infrared camera;
starting from the or each spatial distribution of the temperature of the physico-chemical system, at least one spatial distribution of the local heat flux, representing the kinetics associated with the transformation, is deduced;
the spatial distribution of the local heat flux is deduced from the value for the coefficient of heat exchange of the physico-chemical system;
the value for said coefficient of heat exchange is determined by making an equivalent fluid to the physico-chemical system, which does not undergo transformation, flow inside the flow means;
the value for the coefficient of heat exchange is determined from the value for the coefficient of sensitivity of a camera, said camera allowing the spatial distribution of the temperature along the observation zone to be obtained;
the coefficient of sensitivity is determined by introducing a reference fluid into the flow means, applying different values of electrical power to said reference fluid and by measuring the corresponding rise in temperature at the observation zone;
starting from the or each local spatial heat flux distribution, at least one value is deduced for the overall heat flux associated with the transformation between the two separated points of the flow means;
the physico-chemical system is made to flow at different molar flow rates and for each of said flow rates, at least one spatial distribution of the temperature is observed and/or at least one spatial distribution of the local heat flux is deduced and/or at least one value for the overall heat flux value is deduced;
the variation in the overall heat flux is determined as a function of the molar flow rate and a value for the transformation enthalpy is drawn therefrom;
the internal section of the flow means is in the range 100 μm² [square micrometers] to 25 mm² [square millimeters], in particular in the range 10000 μm² to 1 mm²;
the molar flow rate of the physico-chemical system in the flow means is in the range 100 pmol/s [picomole per second] to 1 mmol/s [millimole per second], preferably in the range 1 nmol/s [nanomole per second] to 100 nmol/s;
the volume of the physico-chemical system in the flow means is in the range 1 nL [nanoliters] to 10 μL [microliters] per centimeter of said flow means;
the dimensions of the flow means and/or the flow rate and/or the molar flow rate of said physico-chemical system are adjusted so that said transformation is complete at the downstream point of the flow means;
the physico-chemical system is a mixture of at least two components and said mixture is made to flow in the flow means in the form of droplets separated by sections of a carrier fluid;
the physico-chemical system is a mixture of two components and said two components are caused to flow in parallel in the flow means;
at least one offline analysis of the physico-chemical system is carried out downstream of the downstream point of the flow means, in particular in a chromatograph; and
when the transformation is not complete at the downstream point of the flow means, the transformation is halted, in particular by means of a quench, then the offline analysis is carried out.

The invention also pertains to a unit for carrying out the above method, comprising:
means for supplying a physico-chemical system;
a flow means in communication with said supply means;
means for imposing a set temperature at all points externally of the walls of the flow means at least between two separated points thereof;
means for observing the spatial distribution of the temperature in the internal volume of the flow means between said two separated points; and
means for determining the or each parameter from the or each spatial distribution.

According to other characteristics of the invention:
the flow means is tubular;
the tubular means is thermally insulating, in particular produced from a polymeric material, especially PTFE;
the means for imposing a set temperature comprise a solid, thermally conductive means having a groove cut therein to receive the tubular flow means;
the thermally conductive means is associated with means for modifying its temperature, in particular a thermostatted base;
the flow means is etched into the walls of the thermally conductive means;
the observing means include an infrared camera;
the supply means comprise means for generating boluses intended to form the physico-chemical system, separated by sections of carrier phase; and
the determination means comprise digital processing means.

The invention is described below with reference to the accompanying drawings given solely by way of non-limiting example, in which:

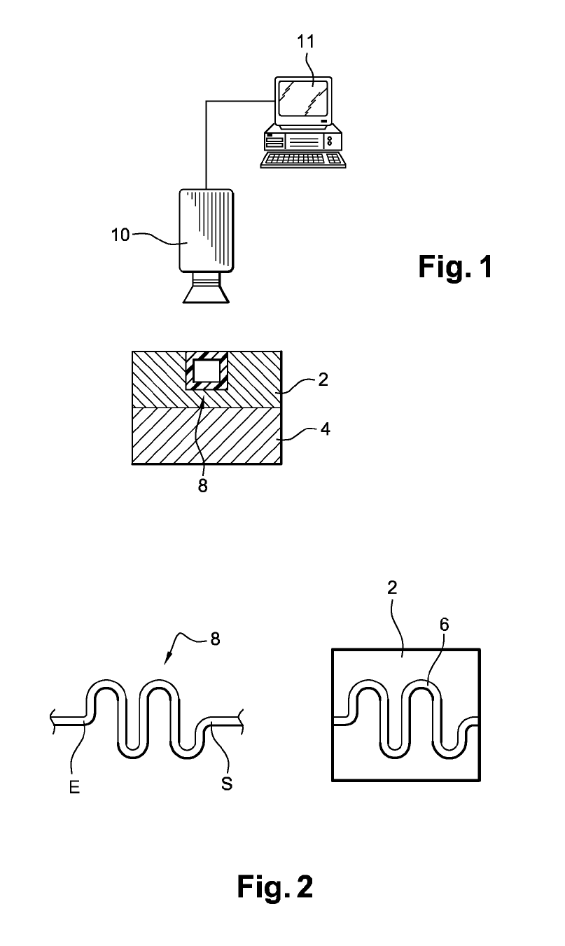

FIG. 1 is a front view that diagrammatically illustrates a unit according to the invention for determining at least one parameter of a transformation;

FIG. 2 is an exploded top view of certain constituent elements of the unit of FIG. 1;

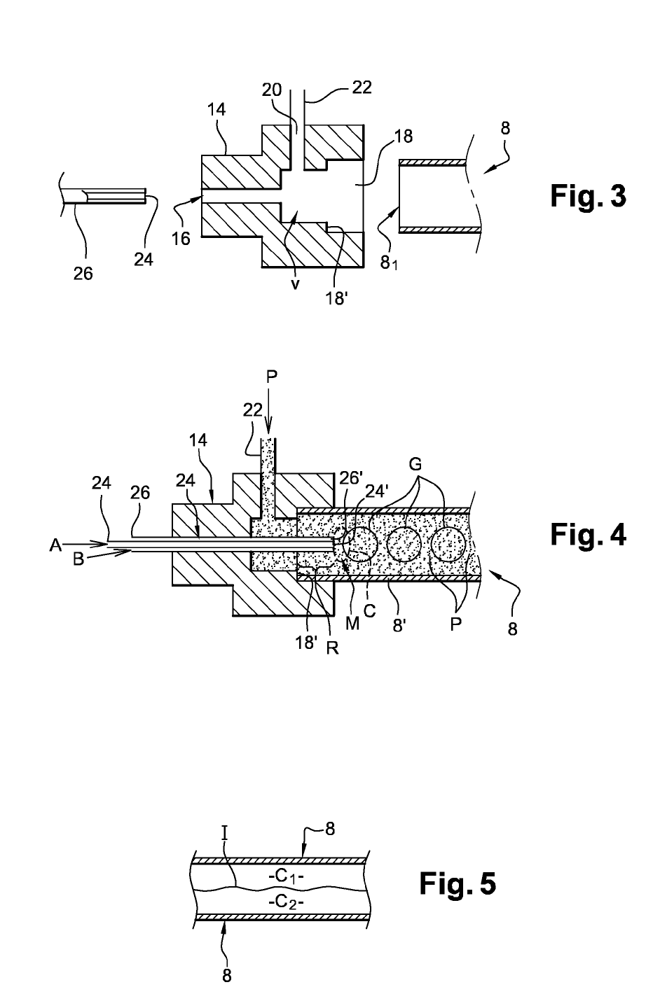

FIGS. 3 and 4 are front views illustrating means for generating boluses belonging to the unit in accordance with the invention;

FIG. 5 is a top view illustrating a type of flow that can be produced in the unit in accordance with the invention; it differs from the flow illustrated in FIG. 4;

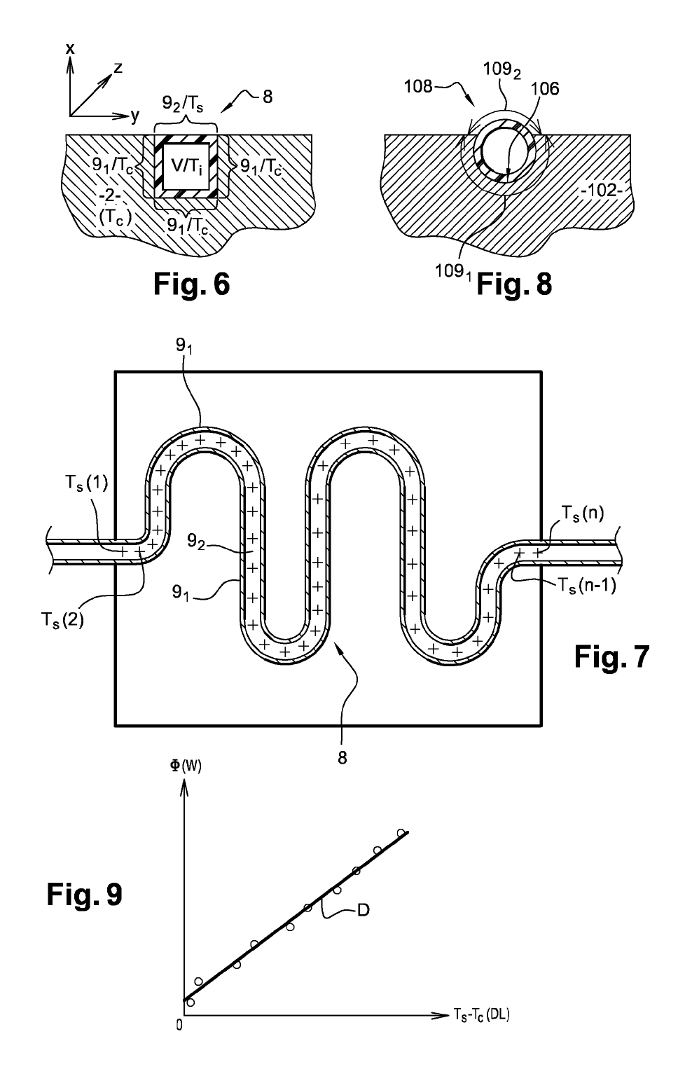

FIG. 6 is a cross-sectional view illustrating in more detail the temperature profile at the external surface of a flow means belonging to the unit of the preceding figures;

FIG. 7 is a top view illustrating this temperature profile along said flow means;

FIG. 8 is a cross-sectional view analogous to FIG. 6 illustrating a variation of the flow means;

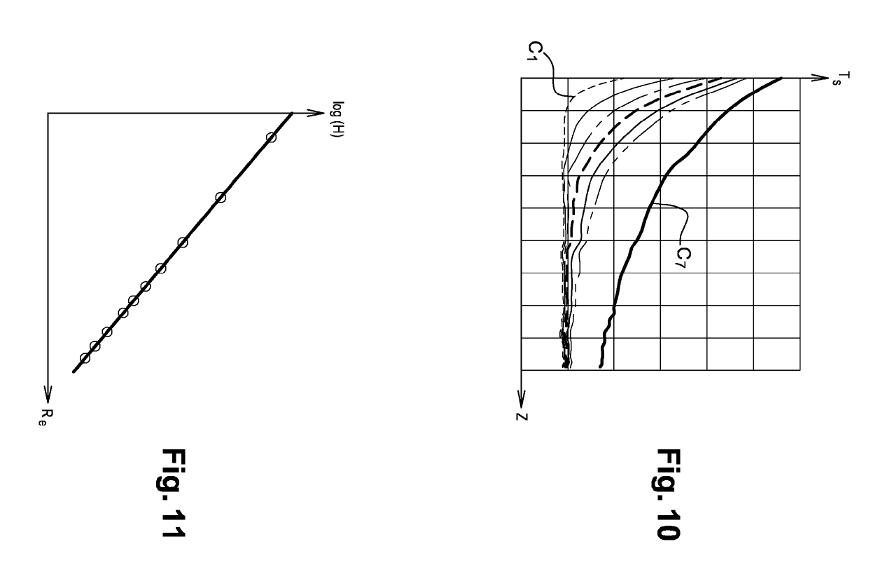

FIG. 9 is a graph illustrating the implementation of a first stage of the method according to the invention;

FIG. 10 is a graph showing various curves illustrating the temperature variation as a function of distance for various flow rates during this second stage;

FIG. 11 is a graph illustrating the determination of an exchange coefficient during said second stage;

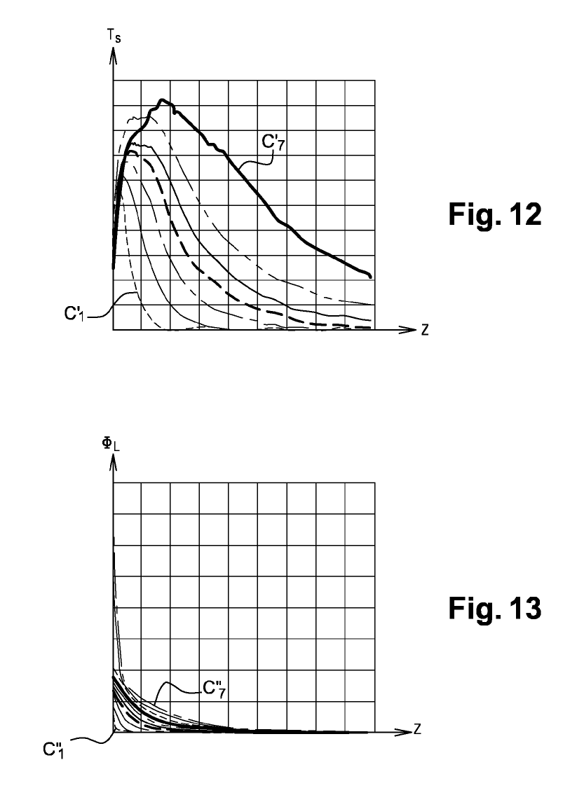

FIG. 12 is a graph analogous to FIG. 10 illustrating different variations in temperature as a function of distance for several flow rates obtained during a third stage of the method of the invention;

FIG. 13 is a graph illustrating the variation in local thermal flux as a function of distance for the various flow rates in FIG. 12;

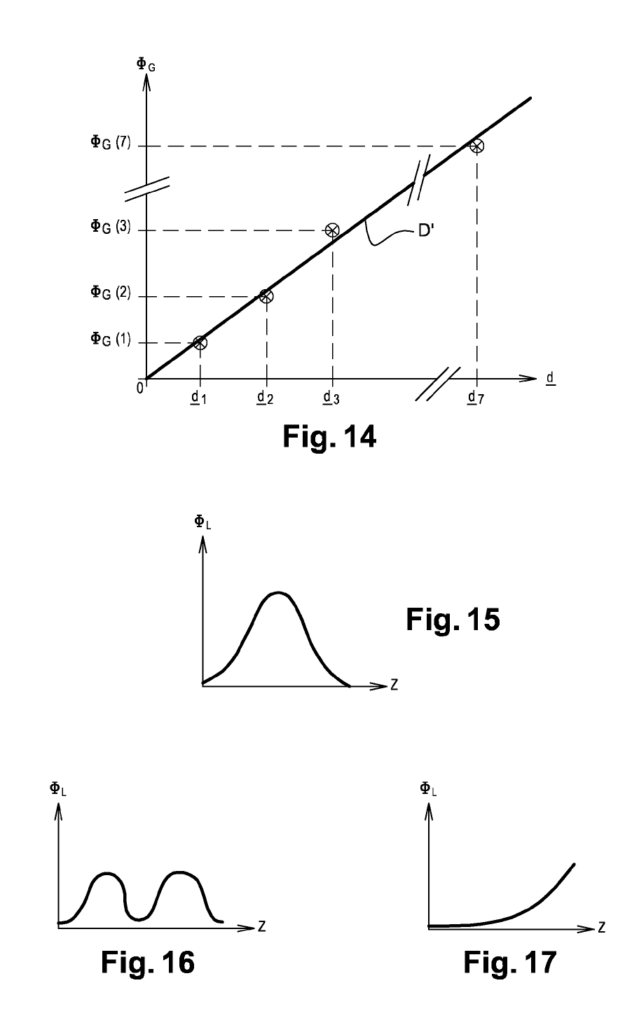

FIG. 14 is a graph illustrating the variation in thermal flux local as a function of molar flow rate when implementing said third stage; and

FIGS. 15 to 17 are graphs analogous to FIG. 13 illustrating the variation in local thermal flux as a function of distance for various types of reaction.

The unit of the invention, illustrated in particular in FIGS. 1 and 2, firstly comprises a block 2 produced from a high heat capacity material such as bronze, or also from aluminum. This block rests on a base 4 that is thermostatted using any appropriate means. An inlet and an outlet for heat transfer fluid are also provided, but they are not shown in the figures. Thus, the temperature of the base can be regulated in a manner that is known per se, as can that of the solid block 2.

This block 2 also has a groove 6 cut into it to receive a tubular means 8 termed the flow means. This flow means has walls that are produced from a thermally insulating material such as PTFE or glass. By way of example, in cross-section, said tubular means 8 has a shape that is polygonal, in particular square, as shown in FIG. 1. However, other profiles may also be provided, in particular a cross-section that is circular.

The transverse dimensions of the internal volume of the flow means 8, defined by the internal walls thereof, are, for example, in the range from about ten micrometers to several millimeters. In a purely non-limiting manner, this internal cross-section is typically in the range 100 μm² (for example 10 μm by 10 μm) to 25 mm² (for example 5 mm by 5 mm). Advantageously, this section is, for example, in the range 10000 μm² (in particular 100 μm by 100 μm) to 1 mm² (in particular 1 mm by 1 mm).

Typically, this range of dimensions brings about a substantially laminar flow in said tube 8, with a very low Reynolds number.

The tubular means 8 may be flexible; this is advantageous since it is then capable of being easily lodged in the receiving groove 6. However, a rigid tubular means, for example produced from glass, may also be provided.

In the example illustrated, said tubular means 8 is “isolated”, i.e. it may be removably fitted in the groove 6. However, in a variation, a flow channel may be produced in the walls of the block 2 using conventional prior art procedures. After the initial etching stage, the peripheral walls of this channel may be produced from an insulating material using any appropriate means.

As can be seen in FIG. 2, the tubular means 8 has undulations, which can increase the length for a given area of the block. The unit of the invention also comprises an infrared camera 10 (or IR camera) of conventional type, directed towards the tubular means 8. Said camera can film the whole of the tubular means 8 between its inlet E and outlet S, which correspond to the points of contact of said tubular means with the opposed edges of the solid block. This IR camera is associated with a processor 11 of any appropriate type.

In the example illustrated, the use of an infrared camera is described. However, it is also possible to use any other type of camera coupled with modulated laser excitation that is capable of measuring a temperature field. Said camera uses thermoreflectivity methods or thermoreflectance methods.

The face of the block 2 turned towards the camera 10 is covered with an opaque film, not shown. Under these conditions, the whole of said surface including the portion of the tubular means 8 facing the camera, can be likened to a thermal black body.

The tubular means 8 is associated with means for generating boluses that are in particular illustrated in FIGS. 3 and 4. Said means firstly comprise an approximately cylindrical connecting means 14 produced from an appropriate material, in particular metal or even a plastics material. Said connecting means include an internal volume V in communication with the outside via three different pathways.

In this regard, said means 14 is first of all provided with a channel 16 and a coaxial chamber 18; they have cross-sections that are respectively smaller than and greater than the cross-section of the internal volume V. Further, a channel 20 termed the upper channel, seen at the top of FIGS. 3 and 4, is cut out in the connecting means 14. A terminal 22 produced, for example, from PEEK, PTFE, silicone, or metal, is fastened to the walls of the opening of said lateral channel 20 using any appropriate means.

The connecting means 14 receives the facing end, denoted 8₁, of the tubular means 8 as well as two capillaries 24 and 26 produced, for example, from PEEK. The capillary 24 has an equivalent diameter that is smaller than that of the capillary 26 given that, as is described in more detail below, in service said capillary 24 penetrates into the internal volume of the capillary 26. Further, said outer capillary 26 has an equivalent diameter that is smaller than that of the flow means 8. Finally, given that the capillary 24 penetrates into the capillary 26, its external diameter is smaller than the internal diameter of the peripheral capillary 26.

In the present text, the term “equivalent diameter” of the various flow means denotes the diameter that the internal walls of said means would have for the same surface area were they of circular cross-section. If they are circular, said equivalent diameter clearly corresponds to the internal diameter of said means.

In order to form the means for generating boluses (see FIG. 4), first of all the outer capillary 26 needs to be inserted into the channel 16 while disposing the inner capillary 24 in the volume of said outer capillary 26. Further, the flow means 8 are placed in the chamber 18 until its end abuts against the shoulder 18′ separating said chamber 18 from the internal volume V.

The outer capillary 26, which is centered on and guided in the channel 16, is inserted until it projects beyond the shoulder 18′. In other words, the walls facing the flow means 8 and the capillary 26 form an overlapping zone denoted R that extends immediately downstream, namely to the right of the shoulder 18′ in FIG. 4. Further, the downstream end 24′ of the inner capillary 24 is flush with the downstream end 26′ of the outer capillary 26, i.e. these two ends occupy the same axial position relative to the main axes of the capillaries 24 and 26.

Said capillaries 24 and 26 receive means for injecting two fluids, of a type that is known per se. The injection means for each fluid comprise a tube, not shown, that is flexible in type, associated with a syringe and a plunger, also not shown. In similar manner, the terminal 22 cooperates with means for injecting a third fluid comprising, for example, an additional tube, also flexible, associated with a syringe and a plunger, not shown.

The operation of the unit described above with reference to FIGS. 1 to 3 is explained below.

In accordance with the invention, at least one parameter, in particular of a thermodynamic nature, is to be determined of a transformation that can occur in the flow tube 8. To this end, and with reference to FIG. 4, two fluids A and B that can form a mixture are injected into the two capillaries 24 and 26; said mixture is capable of undergoing a transformation within the meaning of the invention. Further, an auxiliary fluid P is injected, via the terminal 22, which auxiliary fluid is not miscible with the mixture of the first two said fluids.

The typical injection flow rate for said various fluids is, for example, in the range 500 μL/h to 50 mL/h. The ratio between the flow rate of auxiliary fluid P and the sum of the flow rates of the two fluids A and B is, for example, in the range 0.5 to 10. Advantageously, the flow rate of the auxiliary fluid P is higher than the sum of those for A and B, by a ratio of close to 2, for example.

The auxiliary fluid then flows into the internal volume V, more precisely into the annular space formed by the walls facing the flow means 8 and the outer capillary 26. In addition, immediately downstream of the downstream ends 24′ and 26′ of the capillaries 24 and 26, the two first fluids are brought into mutual contact, in a zone termed a mixing zone, denoted M. Thus, the two reactive fluids that flow in the respective capillaries 24 and 26 are found only at this mixing zone and not upstream therefrom.

Furthermore, immediately downstream of the overlapping zone R, said two fluids A and B are brought into contact with the non-miscible carrier fluid P in a zone termed the contact zone, denoted C. The presence of said zone R means that droplet formation can be observed, meaning that the user can control the proceedings. In the absence of such an overlapping zone, the droplets would be formed in the connecting means 14, which is not necessarily transparent.

Given that the carrier fluid P is not miscible with fluids A and B, droplets G, each of which is constituted by the mixture of A and B, are formed at this contact zone C. It should be noted that the droplets G form boluses, themselves constituting a physico-chemical system in the context of the invention.

As a consequence, by independently imposing the respective flow rates both of the two fluids A and B and of the carrier fluid P, it is possible to form monodisperse droplets G of dispersed phases immediately downstream of capillaries 24 and 26. Given that these droplets are emitted at a constant frequency denoted f, their volume v is given by the formula v=q/f, where q is equal to the sum of the flow rates of A and B. In other words, the measurement of the frequency f, for example using a simple laser pointer illuminating a photodiode, provides access to the volume v of the droplets G, without having to use more complex image processing techniques. Thus, for a given geometrical configuration of the fixed diameters of the means 8 and of the capillaries 24 and 26, it is possible to cause the size of the droplets formed to be varied in a simple manner by modifying only the flow rate of the various immiscible fluids.

The various droplets G produced thereby flow into the flow means 8, it being the location of said transformation. Thus, as the droplets G advance through the capillary, said transformation occurs, namely the nature of the mixture formed by the initial fluids A and B is progressively modified as a function of the degree of progress of the transformation. In other words, the most recently formed droplet, namely that located nearest the left in FIG. 4, comprises the two components A and B that are substantially not mixed. Then, as they move downstream, the two components are increasingly better mixed, and the transformation that is to be studied is more and more advanced.

In the above, each droplet is formed by two components A and B. However, it is possible, in a manner that is known per se, for the droplets to have at least three components.

FIG. 5 illustrates a variation of the invention that does not use bolus generating means. In this variation, the inlet to the tubular means 8 is not associated with bolus creation means, but only with at least two upstream tubes, not shown, each of which admits one reagent into the tubular means 8. Advantageously, the discharge for said two upstream tubes into the flow means 8 is located at the inlet E thereto. As can be seen in FIG. 5, the reagents, here two reagents, C₁ and C₂, flow in a substantially parallel manner at least in the portion upstream of tube 8 either side of an interface I.

It is advantageous to form a succession of droplets, in particular when the transformation occurring between the two components is theoretically very slow. This measure can accelerate mixing of the two components in each droplet. This implementation is also suitable for transformations that run the risk of explosion because each droplet forms a very small volume, thus minimizing the effect of any such explosion. Further, when the components of the droplets are very viscous in nature, the various sections of the carrier phase can allow them to advance in the tube.

In contrast, with parallel flow, as in FIG. 5, the transformation between the two components occurs solely by diffusion in the vicinity of their interface. Thus, in practice, it is advantageous to use this implementation to study transformations that in theory are very rapid, or interfacial in type.

Advantageously, the conditions may be selected such that the transformation that is to be studied is completely finished at the outlet from the flow tube 8. In order for said transformations to be complete, the skilled person is able to adjust the various process parameters, in particular the flow rate of the component flowing in the tube 8, as well as the length thereof.

As an example, the length of the flow tube separating its inlet E from its outlet S is typically in the range 1 cm [centimeter] to 50 cm, while the total flow rate of the components flowing in said tube 8 is in the range 250 μL/h to 10000 μL/h. Further, the total quantity of said components present in the flow tube 8 is advantageously in the range 1 nL to 10 μL per centimeter of channel. The transformation occurring in the tubular means 8 produces a certain amount of heat that may be positive or negative depending on whether the transformation is exothermic or endothermic. Referring to FIG. 6, this then induces a variation in the temperature, denoted Tᵢ, of the components A and B in the internal volume V of the tubular means 8. This variation in the internal temperature will in turn have an influence on the temperature of the walls of the tubular means 8.

However, given the nature of the unit of the invention, the external wall of the tubular means 8 can be divided into two zones, one in contact and one not in contact with the solid block 2. Referring to FIG. 6, since said wall forms a quadrilateral, three sides are in contact with the solid block 2, thereby forming a contact zone denoted 9₁. In contrast, the fourth side of said quadrilateral, not in contact with the solid block 2 and in the field of the camera, forms an observation zone denoted 9₂.

Advantageously, the contact zone 9₁ occupies a substantial fraction of the total periphery of the external wall of the tube 8. The percentage occupied by said contact zone is strictly dependent on the form factor of the tube. Thus, by way of non-limiting example, the length of said contact zone is advantageously greater than 75%, in particular greater than 90% of the total periphery of the external wall of the tube.

Since the solid block 2 is thermally conductive and the walls of the tubular means are thermally insulated, the contact zone 9₁ is at the same temperature at all points, namely along its periphery and along its length. This temperature of said contact zone, termed the set temperature T_{c}, substantially corresponds to that of the solid block 2.

In contrast, the temperature denoted Tₛ of the observation zone 9₂, which is not in contact with the solid block 2, is capable of varying as a function of the fluctuations in the internal temperature Tᵢ. In the top view of FIG. 7, this observation zone 9₂ and two of the sides belonging to the contact zone 9₁ can be seen. Along the flow means 8, the temperature of said contact zone remains constant, as mentioned above, namely at substantially T_{c}. In contrast, the temperature Tₛ of the observation zone is variable as a function of the local heat flux due to the transformation inside the tubular means.

The IR camera 10 then measures the spatial distribution of said temperature Tₛ along the tubular means, namely that henceforth termed the “temperature field”. More precisely, said camera carries out a certain number of discrete temperature measurements at regularly distributed points in the observation zone. The number of these points is typically in the range 100 to 10000, in particular 1000. In FIG. 7, Tₛ(1) to Tₛ(n) denote the various temperatures measured along the tube for which, as was discussed above, n is in the range 100 to 10000. It should also be noted that, in a manner that is known per se, the camera produces a large number of images for each point 1 to n then produces the mean.

FIG. 8 shows a variation of the invention in which the tubular flow means 108 is circular. Under these conditions, the groove 106 produced in the solid block 102 has the form of a portion of a circle, the tube 108 being forcibly inserted in said groove. In cross-section, a contact zone 109₁ can be seen, extending along the major portion of the external periphery of the means 108, as well as an observation zone 109₂, which is not in contact with the solid means 102.

As is explained, the measurement of the temperature fields provides access to parameters, especially thermodynamic parameters, in particular thermochemical parameters, such as enthalpy and kinetics. Before carrying out said stage for measuring the temperature fields inside the tubular means, advantageously, preliminary steps of calibrating the camera and for standardizing the physico-chemical system may be carried out.

The calibration step is intended to determine the response of the camera as a function of the heat flux that may be released by the transformation to be studied. To this end, the reaction medium is replaced by a heater wire emitting a known electric flux.

More precisely, said heater wire, not shown, is introduced into the tubular means 8. Said wire is supplied with electricity using a stabilized supply. In order to know the electrical power (W) dissipated in the volume (m³) of the tubular means, the voltage at the terminals of the heater wire is measured using an appropriate voltmeter.

The calibration stage proper firstly comprises a step of filling the tubular means using a fluid termed “equivalent”, namely having thermal properties similar to that of a mixture of components to be studied. This equivalent fluid must, however, be neutral, i.e. it must not undergo a transformation.

Said equivalent fluid may be formed by the same components as the physico-chemical system to be studied, but in concentrations that are much smaller, in order to prevent a transformation from occurring. Said equivalent fluid may also be identical to the physico-chemical system being studied, but free of a component allowing a transformation to occur, such as a catalyst or polymerization initiator.

Next, various electrical powers are applied to the heater wire, to produce respective gray levels (denoted DL) of the camera.

The following equation is then used:

Φ=hS(Tₛ−T_{c}) (1)

where:
Φ corresponds to the electric flux (W);
hS is the coefficient of sensitivity (W/DL) of the camera;
Tₛ corresponds to the temperature (in DL) of the observation zone 9₂ of the tube 8, which is substantially the same all along said tube; and
T_{c} is the set temperature (in DL) imposed by the block 2, namely equal to that of the contact zone 9₂ of the external walls of the tube 8.

Thus, the variation in this flux Φ is recorded as a function of the temperature difference (Tₛ−T_{c}) in accordance with the curve illustrated in FIG. 9. This variation, which is substantially linear, may be minimized using an appropriate mathematical method such as a linear regression. The slope of the regression line D thus corresponds to the coefficient hS.

This preliminary calibration step is of particular advantage in that it means that the behavior of the camera 10 as a function of experimental parameters can be ascertained. These experimental parameters are in particular the geometrical configuration of the tube, the thermal characteristics of the materials employed, and the operating conditions.

After said calibration step, a standardization step is carried out that aims at evaluating the thermal properties of the components that are to undergo the transformation and that are to be studied. In other words, when the temperature of the fluid at the inlet to the flow channel is different from the set temperature, this standardization can be used to estimate the duration or the distance of flow necessary for the temperature of the components to become equal to the set temperature in the absence of any transformation.

To this end, an “equivalent” fluid, as defined in the above calibration step, is made to flow in the tube 8. When a mixture of components is used, two successive standardizations may be carried out in isolation for each fluid in order to deduce two exchange coefficients therefrom. The overall exchange coefficient is then calculated using a mixing law.

The equivalent fluid flows in the tube 8 at a first flow rate d₁. Using the camera, n values for temperature are then observed along the observation zone 9₂ of the tube 8, as described above with reference to FIGS. 6 and 7. Next, said procedure is started again for different flow rate values, in particular three to twenty values, preferably six to ten values.

It is then possible to trace the change in temperature Tₛ as a function of the curvilinear abscissa Z of the equivalent fluid in the tube 8 for different values of flow rate. These various curves are shown in FIG. 10; it shows seven curves denoted C₁ to C₇ relative to said various flow rates d₁ to d₇, which thus correspond to different speeds.

The thermal exchange coefficient H between the equivalent fluid and the walls of the tube is required for different flow rates. The following equation is used for this purpose:

$$ρ {C}_{ρ} υ \frac{d {T}_{o}}{d x} = - hS ( {T}_{O} - {T}_{C} ) \qquad ( 2 )$$

it being understood that H=hS/pC_{ρ}ν, where ν is the speed of the fluid.

Next, in FIG. 11, the variations in the logarithm of the exchange coefficient H are recorded as a function of the Reynolds number Re, which is proportional to the speed of flow. Given that this variation is linear, this shows that thermal losses are independent of speed. Thus, knowing the standardization coefficient (hS) and the flow rate, it is possible to estimate the product ρC_{ρ} for a system formed by the equivalent fluid and the tube.

Finally, after these two preliminary steps, the two components A and B that may induce a transformation and that are to be studied are made to flow in the tube. Advantageously, the contact zone C (see FIG. 4) is made to coincide with the inlet E (see FIG. 2). This can in fact improve the accuracy of the study since the region where the transformation commences is thus precisely known. Furthermore, it is assumed that these components are admitted at a temperature equal to that, T_{c}, imposed by the block 2.

Next, as mentioned above with the equivalent fluid, the temperature field of the observation zone 9₂ is observed along the tube 8, namely as the transformation undergone by the components A and B advances. Next, the temperature field is observed several times at various flow rates, again in a manner analogous to the steps undertaken with the equivalent fluid.

Under these conditions, various curves that pertain to the change in temperature of the observation zone caused by the heat flux linked to the reaction medium are produced that are a function of the curvilinear abscissa Z of the tube 8. FIG. 12 is thus obtained, showing curves C′₁ to C′₇ corresponding to different flow rate values.

As can be seen above, the two components A and B are admitted into the tube 8 at an initial temperature corresponding to the set temperature T_{c}. Under these conditions, the curves of FIG. 12 correspond uniquely to the variation in temperature caused by the physico-chemical transformation of the components.

However, if these components are admitted at a temperature that differs from the set temperature, then the time necessary for the physico-chemical system to adjust to this set temperature T_{c} independently of the transformation that it is undergoing must be taken into account. The curve of the change in temperature corresponding to a single physico-chemical transformation is then obtained by taking the difference between the experimentally obtained total curve and the curve for the equivalent fluid in the absence of transformation, as can be seen in FIG. 10.

Returning to FIG. 12, it can be seen that for each curve C′₁ to C′₇, the temperature initially increases rapidly, then also decreases rapidly. This means that the transformation being studied is rapid in nature and complete.

The next step consists in determining the values for the local heat flux for each of the n points of the tube 8 for which a local temperature has already been measured. To this end, the following equation is used:

Φ^{L}(i)=(Tₛ(i+1)−Tₛ(i))/(Z(i+1)−Z(i))−H(Tₛ(i)−Tc)

where i varies from 1 to n, i.e. the number of measurements along the tube.

Starting from these n values for the local thermal flux, determined thereby, the change in the local flux Φ_{L} along the abscissa Z can be deduced, as illustrated in FIG. 13. This operation is carried out for the various values for the flow rate d₁ to d₇, meaning that seven curves, denoted C″₁ to C″₇, can be produced. It should be noted that obtaining this local flux value is highly advantageous since it means that the kinetics linked to the transformation being studied can be obtained.

Next, in an additional step, each local heat flux is integrated for the various flow rates. This means that seven values for the overall heat flux Φ_{G} can be obtained between the inlet E and the outlet S. The variation in said flux Φ_{G} is thus obtained as a function of the molar flow rate d, in accordance with the curve illustrated in FIG. 14. This variation, which is substantially linear, may be minimized by an appropriate mathematical method such as a linear regression. The slope of the regression line D′ thus corresponds to the enthalpy of the transformation.

The invention is not limited to the examples described and shown.

Thus, an offline analysis of the reaction mixture may be carried out downstream of tube 8 using any appropriate equipment, in particular a chromatograph. In the event that the transformation is not entirely complete at the outlet from the tubular means, the mixture of components is quenched in order to stop said transformation from progressing further.

In an additional variation, an online analysis of the transformation may also be carried out, namely in the flow tube proper. For this purpose, a Raman type apparatus is used, for example; its beam is directed towards the internal volume of the tubular means.

The invention can achieve the aims mentioned above.

It means that at least one parameter of a physical and/or chemical transformation can be determined in a simple manner using simple components, at a concomitantly relatively lower cost.

Furthermore, the invention makes it possible to cause the composition of the physico-chemical system under study to vary in a very simple manner. In this regard, this variation may be accomplished solely by modifying the flow rates of the substances that make up this physico-chemical system.

It should also be emphasized that the invention can use very small volumes of the physico-chemical system to be studied. This is advantageous firstly for highly exothermic reactions in that it removes all major risks of explosion. Secondly, the use of small volumes is of substantial importance when the physico-chemical system is expensive.

Furthermore, as can be seen in FIG. 13, the invention provides access to data of a local type relative to the transformation to be studied. Thus, as illustrated in this figure, it is possible to determine that the transformation under consideration occurs very rapidly in that the local heat flux Φ_{L} increases immediately then reduces very substantially from the upstream portion of the tubular means.

As can be seen in FIGS. 15 onwards, the invention enables other types of kinetics to be identified. Thus, in FIG. 15, a bell-shaped profile obtained for the local heat flux signifies a moderately fast transformation. In FIG. 16, a double-bell shaped profile is obtained, meaning that the transformation occurs in two successive stages. Finally, the profile shown in FIG. 17 increases very slowly, a characteristic of a transformation that is also very slow.

In all of these figures, the transformations are exothermic, namely that they generate heat. Clearly, the same type of data, i.e. local in type, can be obtained when these reactions are endothermic, resulting in an inversion in the profiles of the thermal flux fields.

It should also be noted that under certain conditions, the various transformations illustrated in FIGS. 13, 15, 16 and 17 are capable of generating identical overall heat fluxes Φ_{G}, even though the profiles for their local heat fluxes Φ_{L} are very different. This demonstrates the advantage of the invention in terms of local information. The prior art using a surface flow measurement cannot be used to determine whether those various transformations have very different profiles for the local thermal fluxes and, as a result, for the kinetics.

An example of carrying out the invention is described below by way of purely non-limiting illustration.

In this regard, the unit of FIGS. 1 to 4 was used. The length of tube 8 between its inlet E and outlet S was equal to 45 cm. This tube, of circular cross-section, had an internal diameter of 1.60 mm and an external diameter of 3.20 mm. The wall proper of said tube, produced from PTFE, was 0.80 mm thick.

Further, the block 2, which had a thickness of 8 mm, had a channel with a shape complementary to that of tube 8 cut into it. Further, an infrared camera of the type available from CEDIP with reference JADE III was used.

The block 2 was maintained at a set temperature of 10° C. In addition, upstream of the tube 8, a strong acid HCl and a strong base NaOH were made to flow in two respective upstream tubes that were separate from each other. The concentration of said acid and said base was 0.45 M, while their first flow rate was 10 mL/h.

Said strong acid and said strong base were brought into contact at the inlet E to tube 8, thereby being placed at a temperature of 10° C. Thus, said acid and said base flowed in parallel as illustrated in FIG. 5, generating a rapid, exothermic neutralization reaction. In other words, bringing them into contact generated a local heat flux that immediately had a high value then decreased rapidly in accordance with a profile corresponding to that of FIG. 12.

Next, various curves illustrating these local heat flux profiles were determined for the various ranges of flow rates from 10 mL/h up to 120 mL/h, that flow rate corresponding to the total flow rate of acid and base. Finally, in a manner analogous to that illustrated in FIG. 14, the variations in total thermal flux were recorded as a function of the molar flow rate. This produced a straight line corresponding to a linear regression of the various recorded points; its slope was 58 kJ/mol [kilojoule/mole]. This value was in very satisfactory agreement with that provided in the literature, namely a theoretical value of 56 kJ/mol.

1.-30. (canceled)

31. A method of determining at least one parameter of a physical and/or chemical transformation, comprising the following steps:
(i) flowing a physico-chemical system subject to transformation within a flow means while maintaining the external periphery of the wall of said flow means at the same temperature, with the exception of an observation zone at least between two axially separated points along said flow means, respectively designated upstream and downstream points;
(ii) observing at least one spatial distribution of the temperature of the physico-chemical system along said observation zone, between said two points, upstream and downstream, at at least one instance; and
(iii) determining the or each parameter from the or each spatial temperature distribution.

32. A method of determining at least one parameter of a physical and/or chemical transformation as defined by claim 31, wherein the flow means comprises a thermally insulating wall and a contact zone of said wall is maintained at the same temperature by contacting same with a solid, thermally conductive means, while the observation zone is not contacted with said solid means.

33. A method of determining at least one parameter of a physical and/or chemical transformation as defined by claim 32, wherein the respective upstream and downstream points along the flow means correspond to the inlet and outlet of the contact zone of said flow means with the thermally conductive means.

34. A method of determining at least one parameter of a physical and/or chemical transformation as defined by claim 32, wherein the flow means comprises a tubular means removably fastened to the thermally conductive means.

35. A method of determining at least one parameter of a physical and/or chemical transformation as defined by claim 31, wherein the or each spatial distribution of the temperature is observed employing an infrared camera.

36. A method of determining at least one parameter of a physical and/or chemical transformation as defined by claim 31, wherein starting from the or each spatial distribution of the temperature of the physico-chemical system, at least one spatial distribution of the local heat flux, representing the kinetics associated with the transformation, is determined.

37. A method of determining at least one parameter of a physical and/or chemical transformation as defined by claim 36, wherein the spatial distribution of the local heat flux is determined from the value for the coefficient of heat exchange of the physico-chemical system.

38. A method of determining at least one parameter of a physical and/or chemical transformation as defined by claim 37, wherein the value for said coefficient of heat exchange is determined by flowing an equivalent fluid to the physico-chemical system, which does not undergo transformation, within the flow means.

39. A method of determining at least one parameter of a physical and/or chemical transformation as defined by claim 37, wherein the or each spatial distribution of the temperature is observed employing an infrared camera, and wherein the value for the coefficient of heat exchange is determined from the value for the coefficient of sensitivity of a camera, said camera allowing the spatial distribution of the temperature along the observation zone to be obtained.

40. A method of determining at least one parameter of a physical and/or chemical transformation as defined by claim 39, wherein the coefficient of sensitivity is determined by introducing a reference fluid into the flow means, applying different values of electrical power to said reference fluid and by measuring the corresponding rise in temperature at the observation zone.

41. A method of determining at least one parameter of a physical and/or chemical transformation as defined by claim 38, wherein, starting from the or each local spatial heat flux distribution, at least one value is determined for the overall heat flux associated with the transformation between the two separated points along the flow means.

42. A method of determining at least one parameter of a physical and/or chemical transformation as defined by claim 31, wherein the physico-chemical system is flowed at different molar flow rates and for each of said flow rates, at least one spatial distribution of the temperature is observed and/or at least one spatial distribution of the local heat flux is determined and/or at least one value for the overall heat flux is determined.

43. A method of determining at least one parameter of a physical and/or chemical transformation as defined by claim 31, wherein the variation in the overall heat flux is determined as a function of the molar flow rate and a value for the transformation enthalpy is determined therefrom.

44. A method of determining at least one parameter of a physical and/or chemical transformation as defined by claim 31, wherein the internal section of the flow means ranges from 100 μm² to 25 mm².

45. A method of determining at least one parameter of a physical and/or chemical transformation as defined by claim 31, wherein the molar flow rate of the physico-chemical system in the flow means ranges from 100 pmol/s to 1 mmol/s.

46. A method of determining at least one parameter of a physical and/or chemical transformation as defined by claim 31, wherein the volume of the physico-chemical system in the flow means ranges from 1 nL to 10 μL per centimeter of said flow means.

47. A method of determining at least one parameter of a physical and/or chemical transformation as defined by claim 31, wherein the dimensions of the flow means and/or the flow rate and/or the molar flow rate of said physico-chemical system are adjusted such that said transformation is complete at the downstream point along the flow means.

48. A method of determining at least one parameter of a physical and/or chemical transformation as defined by claim 31, wherein the physico-chemical system is a mixture of at least two components and said mixture flows in the flow means in the form of droplets separated by sections of a carrier fluid.

49. A method of determining at least one parameter of a physical and/or chemical transformation as defined by claim 31, wherein the physico-chemical system is a mixture of two components and said two components flow in parallel within the flow means.

50. A method of determining at least one parameter of a physical and/or chemical transformation as defined by claim 31, wherein at least one offline analysis of the physico-chemical system is carried out downstream of the downstream point along the flow means, optionally in a chromatograph.

51. A method of determining at least one parameter of a physical and/or chemical transformation as defined by claim 50, wherein, when the transformation is not complete at the downstream point of the flow means, the transformation is halted, optionally by means of a quench, then the offline analysis is carried out.

52. A structured unit for determining at least one parameter of a physical and/or chemical transformation for carrying out the method as defined by claim 31, comprising:
(a) supply means for providing a physico-chemical system;
(b) a flow means in communication with said supply means;
(c) means for establishing a set temperature at all points externally of the walls of the flow means at least between two separated points thereof;
(d) observing means for observing the spatial distribution of the temperature in the internal volume of the flow means between said two separated points; and
(e) determination means for determining the or each parameter from the or each spatial distribution.

53. A structural unit for determining at least one parameter of a physical and/or chemical transformation as defined by claim 52, wherein the flow means is tubular.

54. A structural unit for determining at least one parameter of a physical and/or chemical transformation as defined by claim 53, wherein the tubular means is thermally insulating, optionally produced from a polymeric material.

55. A structural unit for determining at least one parameter of a physical and/or chemical transformation as defined by claim 53, wherein the means for establishing a set temperature comprises a solid, thermally conductive means having a groove cut therein to receive the tubular flow means.

56. A structural unit for determining at least one parameter of a physical and/or chemical transformation as defined by claim 55, wherein the thermally conductive means is associated with means for modifying the temperature thereof, optionally a thermostatted base.

57. A structural unit for determining at least one parameter of a physical and/or chemical transformation as defined by claim 55, wherein the flow means is etched into the walls of the thermally conductive means.

58. A structural unit for determining at least one parameter of a physical and/or chemical transformation as defined by claim 52, wherein the observing means include an infrared camera.

59. A structural unit for determining at least one parameter of a physical and/or chemical transformation as defined by claim 52, wherein the supply means comprises means for generating boluses adopted to form the physico-chemical system, separated by sections of carrier phase.

60. A structural unit for determining at least one parameter of a physical and/or chemical transformation as defined by claim 52, wherein the determination means comprises digital processing means.
